(19) United States
(12) Patent Application Publication
(10) Pub. No.: US 2017/0336599 A1
(43) Pub. Date: Nov. 23, 2017

(54) CORRECTIVE LENS FOR VIEWING TARGET LOCATED AT EXTREMELY SHORT DISTANCE

(71) Applicant: Jin-Tae KIM, Bucheon-si (KR)

(72) Inventor: Jin-Tae KIM, Bucheon-si (KR)

(21) Appl. No.: 15/529,797

(22) PCT Filed: Oct. 20, 2016
(86) PCT No.: PCT/KR2016/011820

§ 371 Date: May 25, 2017

(30) Foreign Application Priority Data
Oct. 27, 2015 (KR) 10-2015-0149237

(51) Int. Cl. G02B 13/00; G02C 7/02; G02B 3/00

(52) U.S. Cl. CPC G02B 13/005; G02B 3/00; G02C 7/02

(57) ABSTRACT

The present invention relates to a corrective lens for viewing a target located at an extremely short distance from the human eye, for example, a display of a head-mounted display (HMD), (hereinafter, called “a target”), namely, for viewing a target that is located at an extremely short distance of 10 mm 100 mm from the center of the pupil (the ‘extremely short distance’ means a distance of 10 mm˜100 mm in the present invention). The corrective lens for viewing a target located at an extremely short distance has S+18 D˜+50 D; C±0.00 D Ax 0°˜360° to C±6.00 D Ax 0°˜360°; and prismatic power of 0˜8Δ, wherein the corrective lens is provided in front of the display of the head-mounted display (HMD).

### TECHNICAL FIELD

The present invention relates to a corrective lens for viewing a target located at an extremely short distance. More particularly, the present invention relates to a corrective lens for viewing a target located at an extremely short distance from the human eye, for example, a display of a head-mounted display (HMD) (hereinafter, called “a target”), namely, for viewing a target that is located at an extremely short distance of 10 mm˜100 mm from the center of the pupil (the ‘extremely short distance’ means a distance of 10 mm˜100 mm in the present invention).

### BACKGROUND ART

The normal eye of a human accurately focuses an image of an object on the retina that is positioned in front of the eye at a distance of about equal to or greater than 6 m. However, when the object is positioned closer than this, the image is focused behind the retina, such that a thick lens is required to increase a refractive index.

This is called the accommodation of the eye. The accommodation ability decreases with age and depends on eye health of a person.

In order to enlarge a close object, reading glasses, a magnifying glass, a loupe, a microscope, etc. are used. In using IT products such as a wearable device, Google Glass, Oculus Rift, Gear VR which are viewed at an extremely short distance (20 mm˜70 mm) from the eyes, even a user with normal vision may have difficulty in viewing a clear image due to misfocus of the optical center caused by heterophoria, strabismus, adjustment and convergence disorder.

A user with abnormal vision, namely, refractive error of the eyes, has difficulty in viewing clear images at extremely short distances without refraction correction.

Particularly, a display of a head-mounted display (HMD) such as a wearable IT device, Oculus Rift, and Gear VR is located in front of the eyes of the user (namely, the center of the pupil) by an extremely short distance of about 70 mm.

One short focal length convex lens has been used to enable viewing the display of the head-mounted display (HMD).

However, this short focal length convex lens is not a corrective lens for the user eye, such that only a user with normal eye health can view the display. Thus, a person with refractive error such as myopia, astigmatism, hyperopia, heterophoria, strabismus, presbyopia, etc. of the eyes cannot view the display without a corrective lens.

When a user with poor vision wears the HMD without glasses, the center distance between the pupils is different. Thus, the optical center (OC) of the installed lens is not focused such that the image on the retina looks differently due to prism effect, and motion sickness, headaches, and diplopia occur.

Also, a user with normal vision (1.0 vision) suffers from prism effect, and thus it is inconvenient to use the HMD.

Also, due to an increase in time for viewing displays of computers, TVs, smart phones, etc. at short distances, eye diseases such lens adjustment and convergence disorders that are an optical system of the eye may occur. Also, gaze is focused on one position for a long time and frequency of blinking the eyes is lessened, thus dry eye occurs (dry eye may cause cornea damage, eye fatigue, discomfort, glare, etc.). When disorders to extraocular muscles are present, light incident into the eyes cannot be accurately focused on the retina, whereby eye diseases such as heterophoria, strabismus, diplopia, blurred vision, headache, dizziness may be caused. In order to solve the problems, it is required to correct vision with a lens for viewing a target located at an extremely short distance.

Recently, hardware performances of HMD devices such as Facebook's Oculus Rift, Samsung's Gear VR, Sony's Project Morpheus, etc. have been rapidly increased, and such hardware is being applied in various fields.

TABLE 1
Application areas of head-mounted displays

| | |
|---|---|
| Entertainment | Experiential contents such as 3D games, |
| | Movies, Traveling, Bungee jumping, and |
| | First-person sports viewing |
| Education | Museum or art gallery experiences, |
| | Astronomical position study, Stereoscopic |
| | study such as architectural design or |
| | chemical molecule design |
| Military | Flight simulation, Battle simulation, Drone |
| | piloting |
| Medicine | Virtual surgery, Remote medical treatment, |
| | Stereoscopic image application such as |
| | anatomy viewing, etc., Various panic |
| | disorder and trauma treatments, Endoscope |
| | viewing, etc. |
| Industry | Virtual experiential product marketing, |
| | Manufacturing process utilization through |
| | robot remote control, Space exploration, |
| | etc. |

As shown in the application examples of table 1, HMDs need to be used for long periods of time. However, users have different eye conditions, and since it is difficult to use a lens for long periods of time that is focused on functions such as gyroscope, positional tracking and the display for a three-dimensional effect of virtual reality.

When refraction correction is not performed depending on the user eye condition, the image focused on the retina is blurred and conditions such as diplopia, eye fatigue, frontal headaches, diplopia, etc. occur due to a binocular vision defect. In addition, symptoms of reading the same line several times or skipping lines when reading books or shoulder discomfort, and sleepiness may occur.

In a general HMD, a convex lens of +20D˜+40 diopter (D) is provided, and a distorted image on a display at an extremely short distance that is the displayed image having a viewing angle of 90°˜100° is viewed with a sense of space (imaging) and with a three-dimensional effect by using the lens. Enlargement magnification and the focal length are set by adjusting a distance between the fixed short focal length convex lens and the column of the head-mounted display (HMD).

That is, an optical unit of the HMD is fixed with the short focal length convex lens. Each user has a different oculus dexter (O.D) and oculus sinister (O.S) in terms of all refractive power systems of the eye and optics, and ocular physiology such as P.D (Pupillary Distance; distance between the centers of the pupils), myopia/hyperopia/astigmatism/presbyopia (degradation of adjustment power of the lens), heterophoria/strabismus, adjustment and convergence, axis of astigmatism, etc. Even though a display with high-resolution is mounted at an extremely short distance (focal length) of 30 mm˜70 mm from the eye, the optic center (O.C) is not focused and the image is blurred and wavering with low resolution depending on the users eye condition.

### DISCLOSURE

### Technical Problem

Accordingly, the present invention has been made keeping in mind the above problems occurring in the related art, and an object of the present invention is to provide a corrective lens for viewing a target located at an extremely short distance from the human eye, for example, a display of a head-mounted display (HMD), namely, for viewing a target that is located at an extremely short distance of 10 mm˜100 mm from the center of the pupil.

Another object of the present invention is to provide a corrective lens for viewing a target located at an extremely short distance in a head-mounted display (HMD), whereby it is possible to view the display without a vision correction unit such as eyeglasses and contact lenses. Also, it is possible to minimize cornea, lens, and retina eye diseases, such as heterophoria, strabismus, and to enhance eye health. Furthermore, a sense of space, which is a specialized feature of a head-mounted display (HMD), binocular stereoscopic vision, and high resolution can be ensured.

### Technical Solution

The present invention provides a corrective lens for viewing a target located at an extremely short distance, the corrective lens having S+18 D˜+50 D, C±0.00 D Ax 0°˜360° to C±6.00 D Ax 0°˜360°, and prismatic power of 0˜8Δ.

Here, the extremely short distance may be a distance of 10 mm˜100 mm between the center of a pupil of an eye and a target ahead.

In addition, the present invention provides a corrective lens for viewing a target located at an extremely short distance, the corrective lens having S+18 D˜+50 D, C±0.00 D Ax 0°˜360° to C±6.00 D Ax 0°˜360°, and prismatic power of 0˜8Δ, and being provided in front of a display of a head-mounted display (HMD).

### Advantageous Effects

As described above, according to the present invention, virtual reality and augmented reality devices can be reduced in size, and can be further utilized in various industries (for example, entertainment, medicine, sightseeing, education, etc.) by using Internet of Things, etc.

Also, according to the present invention, a user having eye disorders such as a person with refractive error (for example, hyperopia, myopia, astigmatism, strabismus, etc.) requiring vision correction, etc. can view an image without a corrective device, and all age groups, particularly, people having poor vision, the elderly, etc. can use the high-tech device.

### DESCRIPTION OF DRAWINGS

FIG. 1 is a view showing a combination relation between a convex lens and a corrective lens for viewing a target located at an extremely short distance according to the present invention.

FIG. 2 is a view showing a corrective lens for viewing a target located at an extremely short distance according to the present invention.

FIG. 3 is a view showing a spherical power of a spherical lens according to the present invention.

FIG. 4 is a view showing a refractive power difference between a reference meridian and another chief meridian of a cylinder lens according to the present invention.

FIG. 5 is a view for explaining a corrective lens device for viewing a target located at an extremely short distance according to the present invention.

FIG. 6 is an exploded perspective view for explaining a corrective lens device for viewing a target located at an extremely short distance according to the present invention.

FIG. 7 is a view for explaining another corrective lens device for viewing a target located at an extremely short distance according to the present invention.

FIG. 8 is a view showing that a corrective lens device for viewing a target located at an extremely short distance is provided in front of a display of a head-mounted display (HMD) according to the present invention.

FIG. 9 is a view showing examples of viewing a display that is a target through a conventional lens, and through correction by a corrective lens of the present invention.

FIG. 10 is a view showing the present invention exploded.

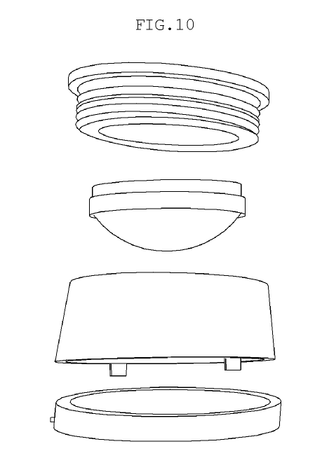

FIG. 11 is a view showing the present invention assembled.

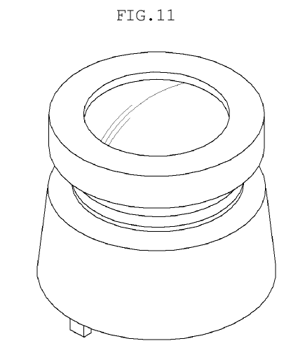

### BEST MODE

Hereinafter, preferred embodiments of the present invention will be described in detail with reference to the accompanying drawings.

Terminologies defined in description of the present invention are defined in consideration of the functions or the shapes, etc. in the present invention and should not be construed as limiting the technical components of the present invention.

The present invention will be described in detail based on aspects (or embodiments). The present invention may, however, be embodied in many different forms and should not be construed as being limited to only the embodiments set forth herein, but should be construed as covering modifications, equivalents or alternatives falling within ideas and technical scopes of the present invention.

Also, for convenience of understanding of the elements, in the figures, sizes or thicknesses may be exaggerated to be large (or thick), may be expressed to be small (or thin) or may be simplified for clarity of illustration, but due to this, the protective scope of the present invention should not be interpreted narrowly.

The terminology used herein is for the purpose of describing particular aspects (or embodiments) only and is not intended to be limiting of the present invention.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, preferred embodiments of the present invention will be described in detail with reference to the accompanying drawings.

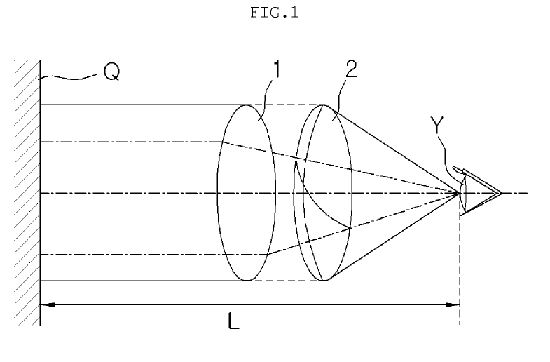

A first exemplary embodiment of the present invention will be described with reference to FIG. 1.

Provided are a convex lens 1 of +20 D˜+40 D and a corrective lens 2 having S±0.00 D±10.00 D, C±0.00 D Ax 0°˜360° to C±6.00 D Ax 0°˜360°, and prismatic power of 0˜8Δ that is for viewing a target located at an extremely short distance of 10 mm˜100 mm.

In a meniscus lens, ±means a front surface, namely, a first surface having a value of (+) diopter, and a rear surface, namely, a second surface having refractive power of (−) diopter, such that the front surface means a (+) surface and the rear surface means a (−) surface.

For example, a lens having refractive power of (−) diopter means that surface refractive power of the (−) surface is larger than that of the (+) surface, and the radius of curvature of the (−) surface is shorter than the radius of curvature of the (+) surface. The lens is a concave lens where the optical center is thinnest.

In the same manner, a lens having refractive power of (+) diopter is a convex lens where the optical center thereof is thickest.

D is the abbreviation for diopter, and is a degree to which a lens converges or diverges effective rays of light. In other words, diopter is a power for changing a vergence, namely, a unit of refractive power (also, a unit of a prescription).

S is the abbreviation for spherical, and stands for a spherical power, and prescriptions of all parts of the spherical lens are the same.

C is the symbol for a cylinder lens that has back vertex power of a meridian having refractive power or has a refractive power difference between a reference meridian and another chief meridian.

Ax is the symbol for an axial meridian of a lens, and means a meridian devoid of refractive power, namely, a meridian devoid of a prescription.

Δ is a unit of prismatic power, and is a unit of indicating a refracted degree of one ray, particularly, a chief ray among the effective rays of light at a particular position in a lens. In other words, Δ is a unit of indicating a size of an angular deviation.

By using the above-described corrective lens according to the first exemplary embodiment of the present invention, it is possible to view a target Q that is positioned a straight distance L of 10 mm˜100 mm ahead of the human eye (pupil) Y.

That is, a prescription of the convex lens 1 ranges +20˜+40 D and is a fixed lens of which all parts evenly have the same refractive power (diopter).

Also, the corrective lens 2 combined with the convex lens has S±0.00 D˜±10.00 D, C±0.00 D Ax 0°˜360° to C±6.00 D Ax 0°˜360°, and prismatic power of 0˜8Δ. Such a lens may be used for the target Q that is positioned a straight distance L of 10 mm˜100 mm ahead of the human eye (pupil) Y.

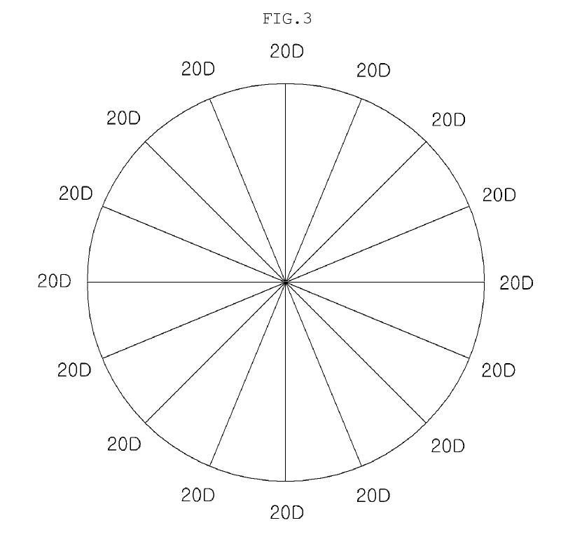

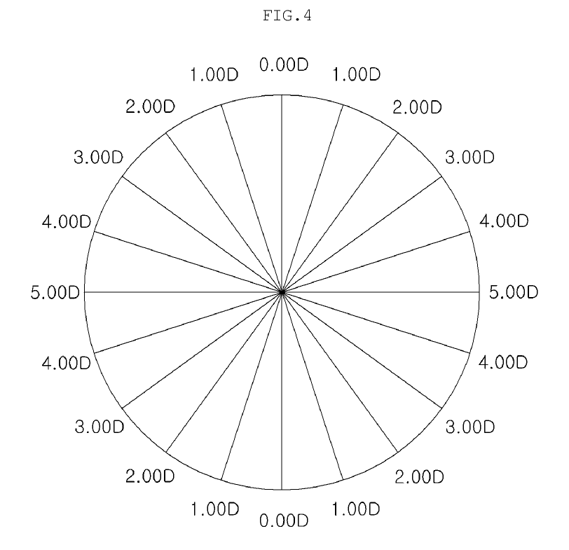

As shown in FIG. 3, the spherical power (spherical) S is a prescription that is the same in the all parts of the spherical lens, and as shown in FIG. 4, the cylinder lens C has a refractive power difference between the reference meridian and another chief meridian.

That is, there is no prescription in one meridian of the reference meridian and another chief meridian perpendicular thereto.

Also, the cylinder lens C has Ax ranging 0°˜360°, and prismatic power ranges 0˜8Δ, whereby in addition to a person with normal vision, a person with refractive error such as myopia, astigmatism, hyperopia, heterophoria, strabismus, presbyopia, etc. of the eyes may view the target Q that is positioned a straight distance L of 10 mm˜100 mm ahead of the eye (pupil) Y without lenses for vision correction (eyeglasses or contact lenses).

As the first exemplary embodiment of the present invention, an example of viewing the target Q, namely, the display that is positioned a straight distance L of 50 mm ahead of the human eye (pupil) Y will be described.

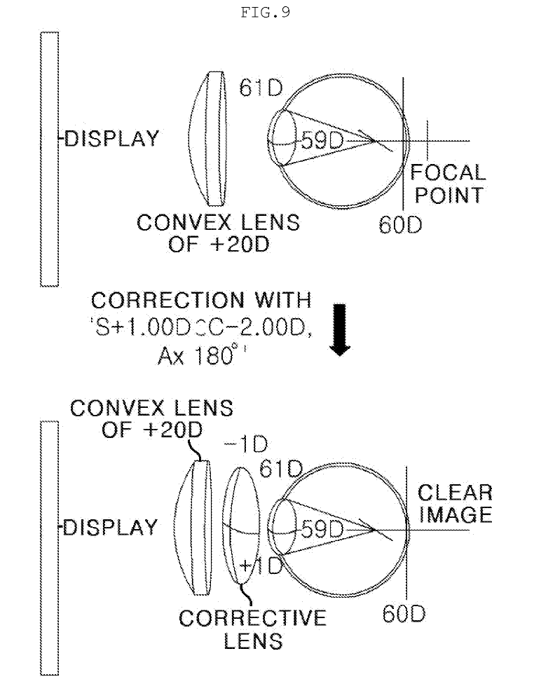

For example, as shown in FIG. 9, in a refractive power system of the eye, normal vision is assumed as +60 D (diopter).

As shown in FIG. 9, the state of the user eye is in mixed astigmatism where the focal points are located in front of and behind the retina

Refractive powers of meridians to which parallel plane rays of light incident to the eye run are different from each other, and thus each meridian may be the same as a toric lens having refractive power of around +60 D (diopter).

When correcting myopia and hyperopia by the use of the spherical lens, the spherical lens compensates with as much refractive power is as necessary to raise or lower the refractive power to be +60 D, which is that of a normal eye. Astigmatism is corrected in the same manner.

However, astigmatism is corrected for each meridian. As shown in the drawing, in the user eye, with regard to each meridian of the astigmatic eye having a toric surface, when a meridian of the eye having refractive power less than normal refractive power of +60 D, a toric lens compensates with as much refractive power as is necessary to raise the refractive power to be +60 D. A meridian having refractive power higher than +60 D is matched with the toric lens having (−) refractive power, whereby the refractive power of +60 D can be obtained. Consequently, every meridian of the astigmatic eye is set to be +60 D so as to correct the vision to a normal optic state when viewing the display.

As shown in the example, the convex lens of +20 D (diopter) that is fixed in front of the eye has a focal length of 50 mm.

In order to view the display at a fixed distance ahead, in a case of a user with myopic mixed astigmatism, which is abnormal vision (eye with refractive error), a steep meridian of 61 D (diopter), namely, the focal point located in front of the retina is pushed backwards and corrected by the use of a lens of −1.00 D, and the focal point of the 59 D (diopter) located behind the retina is corrected by the use of a lens of +1.00 D, whereby the focal point can be located on the retina.

In astigmatism, there are two or more focal points because refractive power of the eye is not the same in all directions such that parallel rays of light do not focus on one focal point in the eye.

For example, when a vertical meridian has refractive power of 61 D (diopter) and a horizontal meridian has refractive power of 59 D (diopter), focal points are located in front of and behind the retina. This eye is described as having mixed astigmatism of 2 D (diopter).

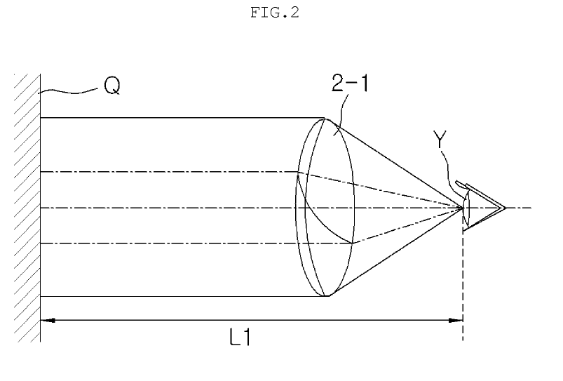

A second exemplary embodiment of the present invention will be described with reference to FIG. 2.

The corrective lens has S+18 D˜+50 D, and C±0.00 D Ax 0°˜360° to C±6.00 D Ax 0°˜360°, and prismatic power of 0˜8Δ. The corrective lens is used for viewing a target located at an extremely short distance of 10 mm˜100 mm.

According to the above-described second exemplary embodiment of the present invention, it is possible to view a target that is positioned a straight distance L1 of 10 mm˜100 mm ahead of the human eye (pupil) Y by the use of a corrective lens 2-1.

The corrective lens has S+18 D˜+50 D, C±0.00 D Ax 0°˜360° to C±6.00 D Ax 0°˜360°, and prismatic power of 0˜8Δ. This corrective lens is used for viewing a target Q that is positioned a straight distance L1 of 10 mm˜100 mm ahead of the human eye (pupil) Y.

As shown in FIG. 3, the spherical power (spherical) S is a prescription that is the same in the all parts of the spherical lens, however, in the second exemplary embodiment of the present invention, S is composed of only the convex lens. Also, as shown in FIG. 4, the cylinder lens C has a refractive power difference between the reference meridian and another chief meridian.

That is, there is no prescription in one meridian of the reference meridian and another chief meridian perpendicular thereto.

Also, in the second exemplary embodiment of the present invention, the cylinder lens C has Ax ranging 0° 360°, and prismatic power ranges 0˜8Δ, whereby in addition to a person with normal vision, a person with refractive error such as myopia, astigmatism, hyperopia, heterophoria, strabismus, presbyopia, etc. of the eyes may view the target Q that is positioned a straight distance L1 of 10 mm˜100 mm ahead of the eye (pupil) Y without lenses for vision correction (eyeglasses or contact lenses).

As a third exemplary embodiment of the present invention, the convex lens of +20 D˜+40 D and the corrective lens having S±0.00 D±10.00 D, C±0.00 D Ax 0°˜360° to C±6.00 D Ax 0°˜360°, and prismatic power of 0˜8 Δ are provided in front of the display of the head-mounted display (HMD).

As described in the first exemplary embodiment, according to the third exemplary embodiment of the present invention, the corrective lens for viewing the target Q that is positioned a straight distance L1 of 10 mm˜100 mm ahead of the eye (pupil) Y is provided in front of the display of the head-mounted display (HMD), whereby in addition to a person with normal vision, a person with refractive error such as myopia, astigmatism, hyperopia, heterophoria, strabismus, presbyopia, etc. of the eyes may view the displayed image with high resolution and with a three-dimensional effect without lenses for vision correction (eyeglasses or contact lenses).

As a fourth exemplary embodiment of the present invention, a corrective lens having S+18 D˜+50 D, C±0.00 D Ax 0°˜360° to C±6.00 D Ax 0°-360°, and prismatic power of 0˜8 Δ is provided in front of the display of the head-mounted display (HMD).

As described in the second exemplary embodiment, according to the fourth exemplary embodiment of the present invention, the corrective lens for viewing the target Q that is positioned a straight distance L1 of 10 mm˜100 mm ahead of the eye (pupil) Y is provided in front of the display of the head-mounted display (HMD), whereby in addition to a person with normal vision, a person with refractive error such as myopia, astigmatism, hyperopia, heterophoria, strabismus, presbyopia, etc. of the eyes may view the displayed image with high resolution and with a three-dimensional effect without lenses for vision correction (eyeglasses or contact lenses).

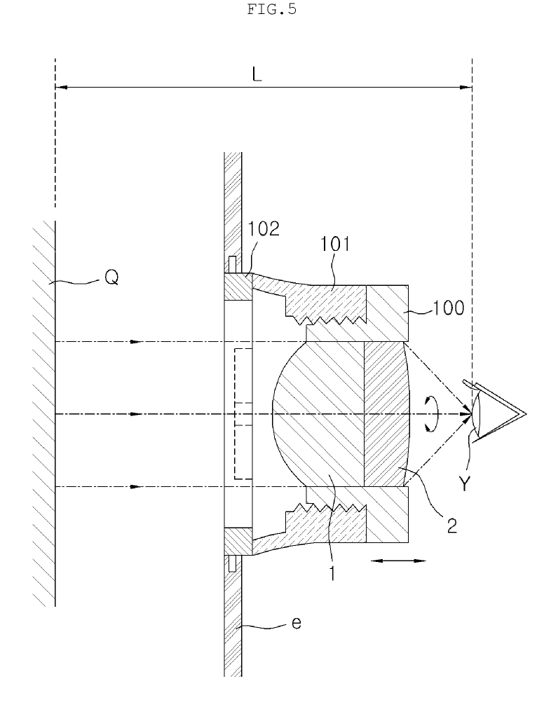

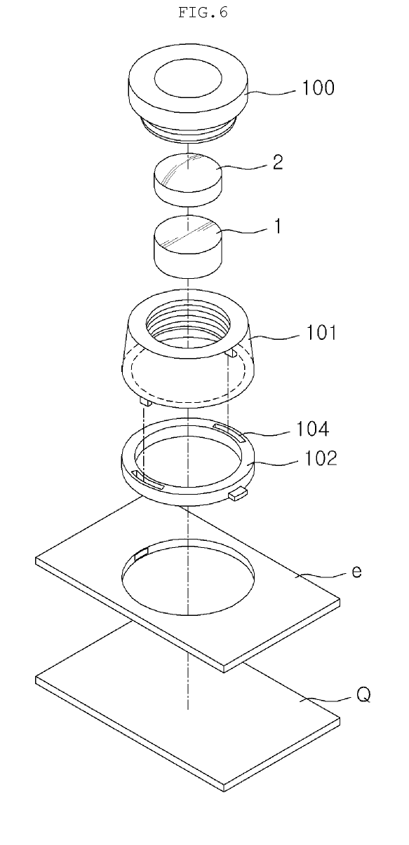

A fifth exemplary embodiment of the present invention will be described with reference to FIGS. 5 and 6.

The convex lens 1 of +20 D˜+40 D and the corrective lens 2 having S±0.00 D±10.00 D, C±0.00 D Ax 0° 360° to C±6.00 D Ax 0°˜360°, and prismatic power of 0˜8 Δ are mounted in a rotary adjustment ring 100 adjusting a focal length, an axial direction, and a deviation direction. The rotary adjustment ring 100 is coupled by screw-type engagement to a cylindrical column 101 adjusting monocular P.D. The cylindrical column 101 is a unit engaged to a slice ring 102 by a guide piece 103 and a guide groove 104.

The slice ring 102 is fixed to a fixing plate e.

The monocular P.D means ½ of a horizontal distance (namely, binocular P.D) between the centers of left and right pupils when the user looks straight ahead, and left and right gazes are parallel to each other. The binocular P.D is adjusted by the monocular P.D.

According to the fifth exemplary embodiment of the present invention, the rotary adjustment ring 100 is provided with the convex lens 1 of +20 D˜+40 D and the corrective lens 2 having S±0.00 D±10.00 D, C±0.00 D Ax 0°˜360° to C±6.00 D Ax 0°˜360°, and prismatic power of 0˜8Δ, whereby it is possible to view the target Q that is positioned a straight distance L1 of 10 mm˜100 mm ahead of the eye (pupil) Y. When rotating the rotary adjustment ring 100, the rotary adjustment ring 100 is moved straight by being coupled to the cylindrical column 101 by screw-type engagement, whereby the focal length is adjusted. Also, by rotating the rotary adjustment ring 100, an axial direction Ax of the cylinder lens C may be matched with an axial direction of the user eye Y.

Also, deviation direction of the eye may be adjusted by configurations of the prism.

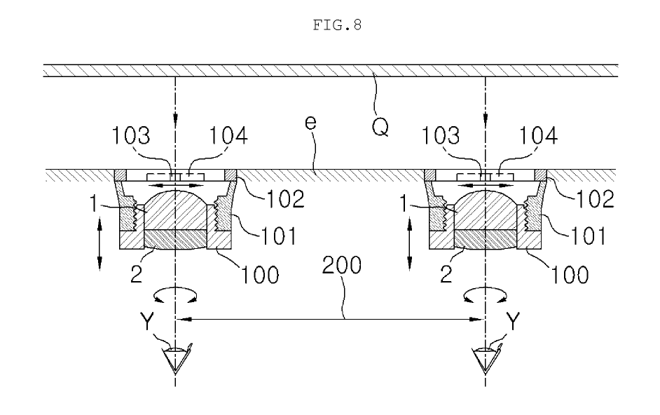

Furthermore, the guide piece 103 of the column 101 may be moved in lateral directions along the guide groove 104 of the slice ring 102 such that the binocular P.D 200 may be adjusted by adjusting the monocular P.D as shown in FIG. 8.

Accordingly, in addition to a person with normal vision, a person with refractive error such as myopia, astigmatism, hyperopia, heterophoria, strabismus, presbyopia, etc. of the eyes may clearly view the target Q that is positioned a straight distance L1 of 10 mm˜100 mm ahead of the eye (pupil) Y without lenses for vision correction (eyeglasses or contact lenses).

Particularly, when the target Q is the display of the head-mounted display (HMD), it is possible to view the displayed image with high resolution and with a three-dimensional effect.

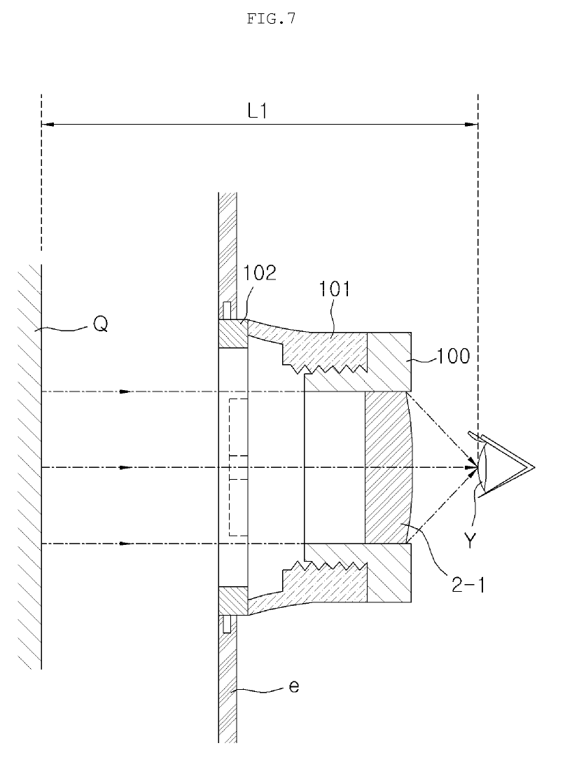

A sixth exemplary embodiment of the present invention will be described with reference to FIG. 7.

The corrective lens 2-1 having S+18 D˜+50 D, C+0.00 D Ax 0°˜360° to C±6.00 D Ax 0°˜360°, and prismatic power of 0˜8Δ is mounted in the rotary adjustment ring 100 adjusting the focal length, the axial direction, and the deviation direction. The rotary adjustment ring 100 is coupled by screw-type engagement to the cylindrical column 101 adjusting monocular P.D. The cylindrical column 101 is engaged to the slice ring 102 by the guide piece 103 and the guide groove 104.

The slice ring 102 is fixed to the fixing plate e.

According to the sixth exemplary embodiment of the present invention, the rotary adjustment ring 100 is provided with the corrective lens 2-1 having S+18 D˜+50 D, C±0.00 D Ax 0°˜360° to C±6.00 D Ax 0°˜360°, and prismatic power of 0˜8Δ, whereby it is possible to view the target Q that is positioned a straight distance L1 of 10 mm˜100 mm ahead of the eye (pupil) Y. When rotating the rotary adjustment ring 100, the rotary adjustment ring 100 is moved straight by being coupled to the cylindrical column 101 by screw-type engagement, whereby the focal length is adjusted. Also, by rotating the rotary adjustment ring 100, the axial direction Ax of the cylinder lens C may be matched with the axial direction of the user eye Y.

Also, deviation direction of the eye may be adjusted by configurations of the prism.

Furthermore, the guide piece 103 of the column 101 may be moved in lateral directions along the guide groove 104 of the slice ring 102 such that the binocular P.D 200 may be adjusted by the monocular P.D as shown in FIG. 8.

Accordingly, in addition to a person with normal vision, a person with refractive error such as myopia, astigmatism, hyperopia, heterophoria, strabismus, presbyopia, etc. of the eyes may clearly view the target Q that is positioned a straight distance L1 of 10 mm˜100 mm ahead of the eye (pupil) Y without lenses for vision correction (eyeglasses or contact lenses).

Particularly, when the target Q is the display of the head-mounted display (HMD), it is possible to view the displayed image with high resolution and with a three-dimensional effect.

As shown in FIGS. 5, 6, and 8, according to a seventh exemplary embodiment of the present invention, the convex lens 1 of +20 D˜+40 D and the corrective lens 2 having S±0.00 D±10.00 D, C±0.00 D Ax 0°˜360° to C±6.00 D Ax 0°˜360°, and prismatic power of 0˜8 Δ are mounted in the rotary adjustment ring 100 adjusting the focal length, the axial direction, and the deviation direction. The rotary adjustment ring 100 is coupled by screw-type engagement to the cylindrical column 101 adjusting monocular P.D. The cylindrical column 101 is a unit engaged to the slice ring 102 by the guide piece 103 and the guide groove 104, and is provided in front of the display of the head-mounted display (HMD).

The seventh exemplary embodiment of the present invention has the same functions and effects as those of the fifth exemplary embodiment. This device of the present invention is provided in front of the display of the head-mounted display (HMD), whereby it is possible to view the displayed image of the head-mounted display (HMD) with high resolution and with a three-dimensional effect.

That is, in addition to a person with normal vision, a person with refractive error such as myopia, astigmatism, hyperopia, heterophoria, strabismus, presbyopia, etc. of the eyes may view the image with high resolution and with a three-dimensional effect without lenses for vision correction (eyeglasses or contact lenses). It is possible to minimize cornea, lens, and retina eye diseases, such as heterophoria, strabismus, and to enhance eye health. Furthermore, a sense of space (imaging), which is a specialized feature of a head-mounted display (HMD), binocular stereoscopic vision, visibility, and high resolution can be ensured.

Also, by considering optics, binocular stereoscopic vision, visibility, and a sense of space (imaging) are excellent. In addition to protecting the eyes of the user of the head-mounted display (HMD), a person with refractive error may use the head-mounted display (HMD) without eyeglasses or contact lenses for vision correction, and thus consumers who previously had difficulty in using the head-mounted display (HMD) may increase.

As shown in FIGS. 7 and 8, according to an eighth exemplary embodiment of the present invention, the corrective lens 2-1 having S+18 D˜+50 D, C±0.00 D Ax 0°˜360° to C±6.00 D Ax 0°˜360°, and prismatic power of 0˜8 Δ is mounted in the rotary adjustment ring 100 adjusting the focal length, the axial direction, and the deviation direction. The rotary adjustment ring 100 is coupled by screw-type engagement to the cylindrical column 101 adjusting monocular P.D. The cylindrical column 101 is a unit engaged to the slice ring 102 by the guide piece 103 and the guide groove 104, and is provided in front of the display of the head-mounted display (HMD).

The eighth exemplary embodiment of the present invention has the same functions and effects as those of the sixth exemplary embodiment. This device of the present invention is provided in front of the display of the head-mounted display (HMD), whereby it is possible to view the displayed image of the head-mounted display (HMD) with high resolution and with a three-dimensional effect.

That is, in addition to a person with normal vision, a person with refractive error such as myopia, astigmatism, hyperopia, heterophoria, strabismus, presbyopia, etc. of the eyes may view the image with high resolution and with a three-dimensional effect without lenses for vision correction (eyeglasses or contact lenses). Thus, consumers who previously had difficulty in using a head-mounted display (HMD) may easily use the HMD as one of IT devices.

Also, it is possible to minimize cornea, lens, and retina eye diseases, such as heterophoria, strabismus, and to enhance eye health, a sense of space (imaging) that is a specialized feature of the head-mounted display (HMD), binocular stereoscopic vision, visibility, and resolution.

In the meantime, according to the exemplary embodiment of the present invention, the corrective lens for viewing a target located at an extremely short distance may be realized as an image transfer device directly providing an image to visual cells of the retina. That is, an image may be provided to the retina by using the angle of the cornea or the contact lens with low-power and the lowest illumination of the image transfer device.

For example, the visual cells of the human may directly recognize the image. Rather than image effect through another medium, a direct clear image and virtual space in real space are created, whereby the device may be simplified. A cornea/retina screen may be realized by using a refraction image of the cornea and the contact lenses so as to maximize virtual reality.

Also, according to the present invention, virtual reality and augmented reality devices can be reduced in size, and can be further utilized in various industries (for example, entertainment, medicine, sightseeing, education, etc.) by using Internet of Things, etc.

Also, according to the present invention, a user having eye disorders such as a person with refractive error requiring vision correction, etc. (for example, hyperopia, myopia, astigmatism, strabismus, etc.) can view an image without a corrective device, and all age groups, particularly, people having poor vision, the elderly, etc. can use the high-tech device.

### INDUSTRIAL APPLICABILITY

The present invention may be widely used in a lens for viewing a target located at an extremely short distance as well as a display of a head-mounted display.

1. A corrective lens for viewing a target located at an extremely short distance, the corrective lens comprising:
S+18 D˜+50 D;
C±0.00 D Ax 0°˜360° to C±6.00 D Ax 0° 360°; and
prismatic power of 0˜8Δ,
wherein the D, S, ±, C, Ax, and Δ are defined as follows,
D: is an abbreviation for diopter, and is a degree to which a lens converges or diverges effective rays of light, diopter meaning a power for changing a vergence, and referring to a unit of refractive power (also, called a unit of a prescription),
S: is an abbreviation for spherical, and stands for a spherical power, and prescriptions of all parts of a spherical lens are the same.
±: means that in a meniscus lens,
a front surface has a value of (+) diopter, the front surface being a first surface,
a rear surface has refractive power of (−) diopter, the rear surface being a second surface, such that the front surface (the first surface) means a (+) surface and the rear surface (the second surface) means a (−) surface,
C: is a symbol for a cylinder lens that has back vertex power of a meridian having refractive power or has a refractive power difference between a reference meridian and another chief meridian,
Ax: is a symbol for an axial meridian of a lens, and means a meridian devoid of refractive power, Ax being a meridian devoid of a prescription, and
Δ: is a unit of prismatic power, and is a unit of indicating a refracted degree of one ray, particularly, a chief ray among the effective rays of light at a particular position in a lens, Δ being a unit of indicating a size of an angular deviation.

2. The corrective lens of claim 1, wherein the extremely short distance is a distance of 10 mm˜100 mm between a center of a pupil of an eye and a target ahead.

3. A corrective lens for viewing a target located at an extremely short distance, the corrective lens comprising:
S+18 D˜+50 D;
C±0.00 D Ax 0°˜360° to C±6.00 D Ax 0°˜360°; and
prismatic power of 0˜8Δ,
wherein the corrective lens is provided in front of a display of a head-mounted display (HMD),
the D, S, ±, C, Ax, and Δ are defined as follows,
D: is an abbreviation for diopter, and is a degree to which a lens converges or diverges effective rays of light, diopter meaning a power for changing a vergence, and referring to a unit of refractive power (also, called a unit of a prescription),
S: is an abbreviation for spherical, and stands for a spherical power, and prescriptions of all parts of a spherical lens are the same.
±: means that in a meniscus lens,
a front surface has a value of (+) diopter, the front surface being a first surface,
a rear surface has refractive power of (−) diopter, the rear surface being a second surface, such that the front surface (the first surface) means a (+) surface and the rear surface (the second surface) means a (−) surface,
C: is a symbol for a cylinder lens that has back vertex power of a meridian having refractive power or has a refractive power difference between a reference meridian and another chief meridian,
Ax: is a symbol for an axial meridian of a lens, and means a meridian devoid of refractive power, Ax being a meridian devoid of a prescription, and
Δ: is a unit of prismatic power, and is a unit of indicating a refracted degree of one ray, particularly, a chief ray among the effective rays of light at a particular position in a lens, Δ being a unit of indicating a size of an angular deviation.
